(19) United States
(12) Patent Application Publication
(10) Pub. No.: US 2023/0122439 A1
(43) Pub. Date: Apr. 20, 2023

(54) METHOD FOR GAZE ANALYSIS AND APPARATUS FOR EXECUTING THE METHOD

(71) Applicant: VisualCamp Co., Ltd., Seoul (KR)

(72) Inventors: Yun Chan SUK, Seoul (KR); Seung Woo LEE, Seoul (KR)

(21) Appl. No.: 17/045,870

(22) PCT Filed: Jun. 11, 2020
(86) PCT No.: PCT/KR2020/007552

§ 371 Date: Oct. 7, 2020

(30) Foreign Application Priority Data
Jan. 13, 2020 (KR) 10-2020-0004162

(51) Int. Cl. H04N 21/442; H04N 21/258; G06F 3/01

(52) U.S. Cl. CPC H04N 21/44218; H04N 21/25891; G06F 3/013

(57) ABSTRACT

A method for gaze analysis according to an embodiment is performed in a computing device including one or more processors and a memory storing one or more programs executed by the one or more processors. The method for gaze analysis may include acquiring gaze tracking information of each user for video content, calculating a degree of gaze concentration for each unit section of the video content based on the gaze tracking information, and calculating gaze concentration rate related information for the video content based on the degree of gaze concentration for each unit section.

### TECHNICAL FIELD

Embodiments of the present invention relate to a gaze analysis technology.

### BACKGROUND ART

In recent years, as a penetration rate of mobile phones increases, the number of users who watch videos (movies, lectures, personal media content, etc.) using the mobile phones is increasing, and accordingly, from the point of view of an advertiser, there is a need for a way to effectively advertise through videos running on the mobile phones. In addition, the number of users (i.e., users who use online shopping malls) who shop using the mobile phones is increasing, and, from the point of view of an online shopping mall operator, there is a need for a way to effectively reflect the needs of users.

### DISCLOSURE OF THE INVENTION

### Technical Problem

An embodiment of the present invention is to provide a method for gaze analysis of a new technique and an apparatus for executing the method.

### Technical Solution

A method for gaze analysis according to a disclosed embodiment is a method performed in a computing device including one or more processors and a memory storing one or more programs executed by the one or more processors, the method for gaze analysis including acquiring gaze tracking information of each user for video content, calculating a degree of gaze concentration for each unit section of the video content based on the gaze tracking information, and calculating gaze concentration rate related information for the video content based on the degree of gaze concentration for each unit section.

The gaze tracking information may be generated in conjunction with a playback time of the video content while the video content is being played on a user terminal of the corresponding user, and may be generated based on a detected Fixation, the Fixation being detected excluding Saccade from a gaze of the user.

The calculating the degree of gaze concentration for each unit section may include calculating a fixation density for each unit section for the video content of the corresponding user based on the gaze tracking information of each user and calculating a degree of gaze concentration for each unit section of users who have viewed the video content based on the fixation density for each unit section for the video content of each user.

The calculating the gaze concentration rate related information may include calculating a gaze concentration rate for each unit section of the video content based on the gaze concentration rate for each unit section of the users who have viewed the video content, summing the gaze concentration rate for each unit section of the video content and dividing the summed gaze concentration rate by the total number of unit sections of the video content to calculate a total gaze concentration rate of the video content, indexing a degree of user interest for the video content according to one or more of an age, a gender, and a district of the users who have watched the video content based on the gaze concentration rate for each unit section and the total gaze concentration rate of the video content, and recommending the video content to a predetermined user according to the degree of user interest indexed according to one or more of the age, the gender, and the district of the users.

The calculating the gaze concentration rate related information may include calculating a gaze concentration rate for each unit section of the video content based on the degree of gaze concentration for each unit section of the users who have viewed the video content.

The calculating the gaze concentration rate related information may further include summing the gaze concentration rate for each unit section of the video content and dividing the summed gaze concentration rate by the total number of unit sections of the video content to calculate a total gaze concentration rate of the video content and assigning a content rating to the video content based on one or more of the gaze concentration rate for each unit section and the total gaze concentration rate of the video content.

Calculating an advertisement unit price of each piece of content according to the content rating after the assigning the content rating may be further included.

The calculating the gaze concentration rate for each unit section of the video content may include calculating a gaze concentration rate for each unit section of the video content for each day of the week for the users who have viewed the video content by day of the week and calculating a gaze concentration rate for each unit section of the video content for each season for users who have viewed the video content by each season.

The method for gaze analysis may further include determining one or more of a type of advertisement to be included in the video content and an insertion section of the advertisement based on the gaze concentration rate related information for the video content.

The determining may include determining a section in which the gaze concentration rate for each unit section of the video content is equal to or higher than a preset reference gaze concentration rate as an advertisement insertion section.

Inserting an advertisement into the advertisement insertion section after the determining as the advertisement insertion section may be further included, and in the inserting the advertisement into the advertisement insertion section, the advertisement may be inserted in a region of the video content with the highest fixation density or in the vicinity of the region with the highest fixation density.

The determining may include summing the gaze concentration rate for each unit section of the video content and dividing the summed gaze concentration rate by the total number of unit sections of the video content to calculate a total gaze concentration rate of the video content, assigning a content rating to the video content based on one or more of the gaze concentration rate for each unit section and the total gaze concentration rate of the video content, extracting an advertisement group corresponding to the content rating of the video content from among preset advertisement groups, determining a section in which the gaze concentration rate for each unit section of the video content is equal to or higher than a preset reference gaze concentration rate as an advertisement insertion section, and extracting an advertisement from the extracted advertisement group according to the gaze concentration rate for each unit section of the video content to insert the advertisement into the advertisement insertion section.

A computing device according to a disclosed embodiment includes one or more processors, a memory, and one or more programs, in which the one or more programs are stored in the memory and configured to be executed by the one or more processors, and the one or more programs include an instruction for acquiring gaze tracking information of each user for video content, an instruction for calculating a degree of gaze concentration for each unit section of the video content based on the gaze tracking information, and an instruction for calculating gaze concentration related information for the video content based on the degree of gaze concentration for each unit section.

A computing device according to a disclosed embodiment includes one or more processors, a memory, and one or more programs, in which the one or more programs are stored in the memory and configured to be executed by the one or more processors, and the one or more programs include an instruction for acquiring video content, an instruction for acquiring gaze tracking information of each user for video content, and an instruction for calculating a degree of gaze concentration of the user for each unit section of the video content based on the gaze tracking information, and the gaze tracking information is generated in conjunction with a playback time of the video content while the video content is being played on the computing device, and is generated based on a detected Fixation, the Fixation being detected excluding Saccade from a gaze of the user.

### Advantageous Effects

According to the disclosed embodiment, it is possible to check a degree of gaze concentration for each section of each piece of content by generating gaze analysis information based on the gaze tracking information of the user for each piece of content. Through this, it is possible to insert the advertisement by checking the section with good advertisement effect in the content and calculate an advertisement unit price differently according to the degree of gaze concentration for each unit section.

### BRIEF DESCRIPTION OF THE DRAWINGS

FIG. 1 is a diagram illustrating a configuration of a gaze analysis system according to an embodiment of the present invention.

FIG. 2 is a diagram for illustrating that a gaze concentration degree calculation unit calculates fixation density in a region of interest in a disclosed embodiment.

FIG. 3 is a view illustrating a state of calculating a gaze concentration for each unit section of content in an embodiment of the present invention.

FIG. 4 is a block diagram illustrating a configuration of a content providing device according to the embodiment of the present invention.

FIG. 5 is a graph illustrating a state of determining a time point to insert an advertisement in the content in the embodiment of the present invention.

FIG. 6 is a block diagram for illustratively describing a computing environment including a computing device suitable for use in exemplary embodiments.

### MODE FOR CARRYING OUT THE INVENTION

Hereinafter, specific embodiments of the present invention will be described with reference to the accompanying drawings. The following detailed description is provided to aid in a comprehensive understanding of a method, a device and/or a system described in the present specification. However, the detailed description is only for illustrative purpose and the present invention is not limited thereto.

In describing the embodiments of the present invention, when it is determined that a detailed description of known technology related to the present invention may unnecessarily obscure the gist of the present invention, the detailed description thereof will be omitted. In addition, terms to be described later are terms defined in consideration of functions in the present invention, which may vary depending on intention or custom of a user or operator. Therefore, the definition of these terms should be made based on the contents throughout this specification. The terms used in the detailed description are only for describing the embodiments of the present invention and should not be used in a limiting sense. Unless expressly used otherwise, a singular form includes a plural form. In this description, expressions such as “including” or “comprising” are intended to indicate any property, number, step, element, and some or combinations thereof, and such expressions should not be interpreted to exclude the presence or possibility of one or more other properties, numbers, steps, elements other than those described, and some or combinations thereof.

In the following description, terms such as “transmission”, “communication”, “sending”, “reception” of a signal or information, or other terms having similar meanings to these terms include not only a meaning that a signal or information is directly sent from one component to another component, but also a meaning that a signal or information is sent via another component. In particular, “transmitting” or “sending” a signal or information to one component indicates that the signal or information is “transmitted” or “sent” to the final destination of the signal or information, and does not mean that the component is a direct destination of the signal or information. The same is true for the “reception” of a signal or information. Also, in this specification, the fact that two or more pieces of data or information are “related” to each other means that when one piece of data (or information) may be acquired, at least a part of pieces of other data (or information) may be acquired based on the acquired data (information).

Meanwhile, directional terms such as upper side, lower side, one side, and the other side are used in relation to the orientation of the disclosed drawings. Since the constituent elements of the embodiments of the present invention may be positioned in various orientations, the directional terms are used for illustrative purposes, but is not limited thereto.

In addition, terms such as first and second may be used to describe various components, but the components should not be limited by the terms. The terms described above may be used for the purpose of distinguishing one component from another component. For example, without departing from the scope of the present invention, a first component may be referred to as a second component, and similarly, the second component may also be referred to as the first component.

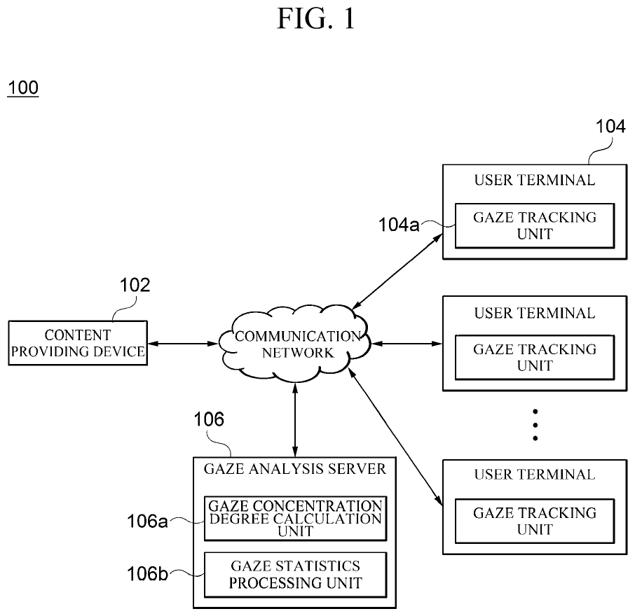

FIG. 1 is a diagram illustrating a configuration of a gaze analysis system according to an embodiment of the present invention.

Referring to FIG. 1, a gaze analysis system 100 may include a content providing device 102, a user terminal 104, and a gaze analysis server 106. The content providing device 102, the user terminal 104, and the gaze analysis server 106 are each communicably connected through a communication network 150.

In some embodiments, the communication network 150 may include the Internet, one or more local area networks, wide area networks, cellular networks, mobile networks, other types of networks, or combinations of these networks.

The content providing device 102 may provide content to the user terminal 104. Here, the content is content displayed on a screen of the user terminal 104, and may be, for example, video content (dynamic content) having a length of play time such as a movie, a drama, a lecture, a news, a broadcast (e.g., an entertainment broadcast, a documentary broadcast, etc.). However, the content is not limited thereto, and the content may also include static content such as a web page or a document file. Hereinafter, for convenience of description, it will be described as an example that the content is video content.

In an exemplary embodiment, the content providing device 102 may provide content to the user terminal 104 through a real-time broadcast or recorded broadcast. In this case, the content providing device 102 may be a server that provides content (e.g., KBS or MBC, etc.) through a public broadcast, or may be a server that provides content through a personal broadcast (e.g., YouTube, etc.).

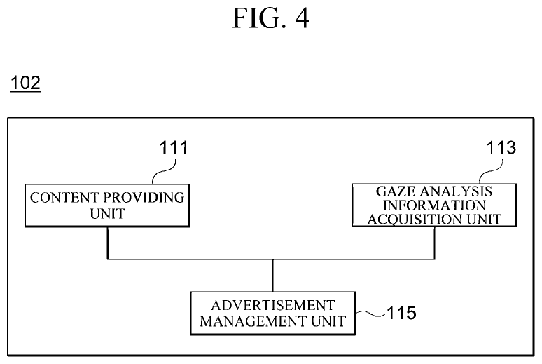

In addition, the content providing device 102 may provide the content to the user terminal 104 in a streaming method or a video on demand (VOD) method according to a content request of the user terminal 104. However, the present invention is not limited thereto, and the content providing device 102 may provide the content to the user terminal 104 through various methods other than that. A detailed description of an operation and configuration of the content providing device 102 will be described later with reference to FIG. 4.

The user terminal 104 may display the content provided from the content providing device 102 on a screen (display). The user terminal 104 may be, for example, an electronic device having a screen such as a smart phone, a notebook computer, a tablet PC, and a desktop PC.

The user terminal 104 may track a gaze of the user within the screen when the content is displayed on the screen. To this end, the user terminal 104 may include a gaze tracking unit 104a for tracking the gaze of the user in the screen. The gaze tracking unit 104a may be implemented through a camera and an application provided in the user terminal 104, but is not limited thereto and may be provided as a separate device and mounted on the user terminal 104.

The gaze tracking unit 104a may generate gaze tracking information of the user in conjunction with a playback time of the content while the content is being played on the user terminal 104. When the content is displayed on the screen, the gaze tracking unit 104a tracks the gaze of the user within the screen, but may detect Fixation excluding Saccade from the tracked gaze of the user.

Here, Saccade is an eye movement in which both eyes move rapidly in the same direction at the same time, which occurs between fixations, and generally lasts 20 to 40 ms. The saccade is mainly used to direct a gaze toward an object of interest. In addition, Fixation means that the gaze is maintained at a single position, and may mean that the gaze is fixed. The fixation may generally last 50 to 600 ms.

The gaze tracking unit 104a may generate gaze tracking information including one or more of information about a position where a fixation has occurred in the screen in conjunction with the playback time of the content, content identification information, and user identification information. The user terminal 104 may transmit the gaze tracking information of the user to the gaze analysis server 106.

The gaze analysis server 106 may receive the gaze tracking information from each user terminal 104 and generate gaze analysis information of the user for the content based on the gaze tracking information. Here, the gaze analysis information may include gaze concentration degree information and gaze statistics analysis information of the content. The gaze analysis server 106 may transmit the gaze analysis information to the content providing device 102. The gaze analysis server 106 may include a gaze concentration degree calculation unit 106a and a gaze statistics processing unit 106b.

The gaze concentration degree calculation unit 106a may calculate a degree of gaze concentration of the corresponding user for each unit section of the corresponding content based on the gaze tracking information. For example, the unit section may be 1 second, but is not limited thereto. Here, the degree of gaze concentration may include fixation density (the number of fixations per unit area). That is, the gaze concentration degree calculation unit 106a may calculate the density of fixations of the corresponding user by unit section of the content.

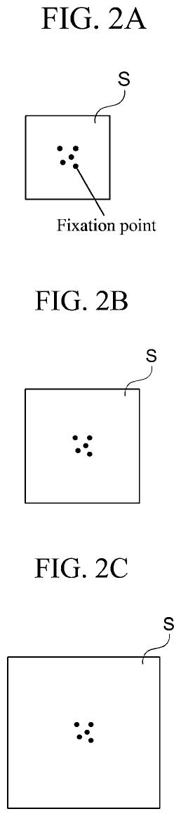

In an exemplary embodiment, the gaze concentration degree calculation unit 106a may calculate the fixation density within a preset region of interest in the content. FIG. 2 is a diagram for illustrating that the gaze concentration degree calculation unit calculates 106a calculates the fixation density in a region of interest in the disclosed embodiment.

Referring to FIG. 2A, when an area of the region of interest (S) is 20×20 pixels and the number of fixations is five, the fixation density is 5/(20×20)=0.0125.

Referring to FIG. 2B, when the area of the region of interest (S) is 30×30 pixels and the number of fixations is five, the fixation density is 5/(30×30)=0.00555.

Referring to FIG. 2C, when the area of the region of interest (S) is 40×40 pixels and the number of fixations is five, the fixation density is 5/(40×40)=0.00315.

The numbers of fixations are all five in FIGS. 2A to 2C, but it can be seen that the fixation density is the highest in FIG. 2A. For example, when video content is displayed on the screen of the user terminal 102, the gaze concentration degree calculation unit 106a may respectively calculate the fixation density by region of interest based on the gaze tracking information and check which region the degree of gaze concentration of the user is high.

Herein, it has been described that the fixation density is calculated for the preset region of interest of the content, but is not limited thereto, and the fixation density may be calculated for the entire region of the content. In this case, it is possible to check at what moment the user is concentrating on and watching the content.

In addition, although it has been described here that the gaze analysis server 106 calculates the degree of gaze concentration of the corresponding user for each unit section, the user terminal 104 may calculate the degree of gaze concentration of the corresponding user for each unit section, and transmit the degree of gaze concentration to the gaze analysis server 106.

The gaze statistics processing unit 106b may generate gaze statistical analysis information based on the degree of gaze concentration for each unit section of respective users by each piece of content.

Specifically, for each piece of content, the gaze statistics processing unit 106b may acquire the degree of gaze concentration for each section of users who have viewed the corresponding content. The gaze statistics processing unit 106b may calculate a gaze concentration rate for each unit section of the content based on the degree of gaze concentration for each unit section of the users who have viewed the content. For example, when a total of 1,500 persons have watched the content, a ratio of the number of viewers who concentrated their gaze for each unit section of the content among the total number of viewers may be calculated.

The gaze statistics processing unit 106b may calculate the total gaze concentration rate of the corresponding content through the gaze concentration rate for each unit section of the content. That is, the total gaze concentration rate of the content may be calculated by summing the gaze concentration rate for each unit section of the content and dividing the summed gaze concentration by the total number of unit sections of the content.

The gaze statistics processing unit 106b may assign a content rating to each piece of content based on one or more of the gaze concentration rate for each unit section of each piece of content and the total gaze concentration rate of each piece of content. In an exemplary embodiment, the gaze statistics processing unit 106b may assign the content rating to a content according to the number of sections in which the gaze concentration rate for each unit section exceeds a preset upper limit gaze concentration rate (e.g., 70%, etc.) in the corresponding content. In addition, the gaze statistics processing unit 106b may assign the content rating to content according to the total gaze concentration rate of the corresponding content.

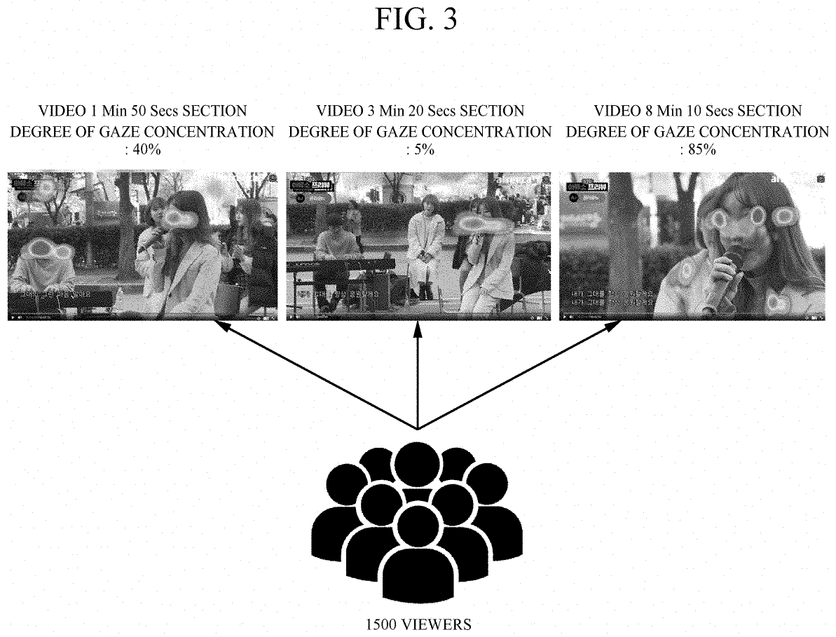

FIG. 3 is a view illustrating a state of calculating the gaze concentration rate for each unit section of content A in an embodiment of the present invention, and Table 1 is a table illustrating the gaze concentration rate and the total gaze concentration rate for each unit section of the content A in the embodiment of the present invention. Here, it is illustrated that the total number of users who have watched the content A is 1,500. For convenience of description, an arbitrary unit section is selected and illustrated.

TABLE 1

| | number of viewers who | gaze |
|---|---|---|
| content unit section | have concentrated on | concentration rate |
| . . . | . . . | . . . |
| 1 minute 50 seconds | 600 viewers | 40% |
| 3 minutes 20 seconds | 75 viewers | 5% |
| 8 minutes 10 seconds | 1275 viewers | 85% |
| | total gaze concentration rate | 76% |

The gaze statistics processing unit 106b may assign a content rating to the content A as a first rating based on the gaze concentration rate for each unit section and the total gaze concentration rate of the content A.

In addition, Table 2 is a table illustrating the gaze concentration rate and total gaze concentration rate for each unit section of content B in the embodiment of the present invention. Here, it is illustrated that the total number of users who have watched the content B is 1,500.

TABLE 2

| | number of viewers who | gaze |
|---|---|---|
| content unit section | have concentrated on | concentration rate |
| . . . | . . . | . . . |
| 1 minute 5 seconds | 75 viewers | 5% |
| 2 minutes 30 seconds | 120 viewers | 8% |
| 9 minutes 20 seconds | 180 viewers | 12% |
| | total gaze concentration rate | 7% |

The gaze statistics processing unit 106b may assign a content rating to the content B as a fourth rating based on the gaze concentration rate for each unit section and the total gaze concentration rate of the content B. In this way, using the gaze concentration rate for each unit section and the total gaze concentration rate of the content, whether users are interested in and concentrated on the content may be expressed with a content rating. Such a content rating may be used to calculate a unit price of advertisements included in the content. In addition, the content rating can be used for content recommendation and exposure algorithm.

In addition, the gaze statistics processing unit 106b may calculate a gaze concentration rate of each piece of content by day of the week. That is, the gaze statistics processing unit 106b may calculate the gaze concentration rate of the corresponding content for each day of the week for users who have watched the content on each day of the week by Monday, Tuesday, Wednesday, Thursday, Friday, Saturday, and Sunday. In this case, the gaze concentration rate may be the gaze concentration rate for each unit section, or the total gaze concentration rate.

In addition, the gaze statistics processing unit 106b may calculate the gaze concentration rate for each piece of content by season. That is, the gaze statistics processing unit 106b may calculate the gaze concentration rate of the corresponding content for each season for users who have watched the corresponding content for each season by each of spring, summer, autumn, and winter.

The gaze statistics processing unit 106b may generate a gaze concentration rate trend pattern of each piece of content based on gaze concentration rate related information (e.g., gaze concentration rate for each unit section, total gaze concentration rate, gaze concentration rate or each day of the week, gaze concentration rate for each season, etc.) of each piece of content. The gaze statistics processing unit 106b may update the gaze concentration related information of the corresponding content based on gaze tracking information of the user who has newly watched as the number of users who have watched the content for each piece of content increases.

FIG. 4 is a block diagram illustrating a configuration of the content providing device 102 according to an embodiment of the present invention.

Referring to FIG. 4, the content providing device 102 may include a content providing unit 111, a gaze analysis information acquisition unit 113, and an advertisement management unit 115. In one embodiment, the content providing unit 111, the gaze analysis information acquisition unit 113, and the advertisement management unit 115 may be implemented using one or more physically separated devices, or may be implemented by one or more processors or a combination of one or more processors, and unlike the illustrated example, these units may not be clearly distinguished in specific operations.

The content providing unit 111 may provide content to the user terminal 104 through the communication network 150. The content providing unit 111 may provide content including an advertisement to the user terminal 104 under the control of the advertisement management unit 115. The content provider 111 may recommend content to the user terminal 104 according to gaze analysis information on the content. For example, the content providing unit 111 may index degrees of interest of users for each piece of content based on gaze concentration related information of each piece of content. In this case, the degrees of interest of users for each piece of content may be indexed according to the gender, the age, and the district of the users. The content providing unit 111 may recommend, to the user terminal 104, content having a degree of interest equal to or higher than a preset level among pieces of contents to users having the same or similar the gender, age, district, etc. as or to those of the corresponding user based on user information (gender, age, district, etc.) of the user terminal 104.

The gaze analysis information acquisition unit 113 may acquire gaze analysis information for each piece of content from the gaze analysis server 106. Here, the gaze analysis information may include the degree of gaze concentration of each user for each unit section of the corresponding content. In addition, the gaze analysis information may include gaze concentration rate related information (e.g., gaze concentration rate for each unit section, total gaze concentration rate, gaze concentration rate for each day of the week, gaze concentration rate for each season, etc.) of the corresponding content. In addition, the gaze analysis information may include the gaze concentration rate trend pattern of the corresponding content. In addition, the gaze analysis information may include content rating information of the corresponding content.

The advertisement management unit 115 may determine one or more of a type of advertisement to be included in the content, an insertion time point of the corresponding advertisement, and an insertion region of the corresponding advertisement according to the gaze analysis information.

In an exemplary embodiment, the advertisement management unit 115 may determine an insertion section of an advertisement to be inserted into the corresponding content and a type of an advertisement to be inserted based on the gaze concentration rate related information on the content provided by the content providing device 102.

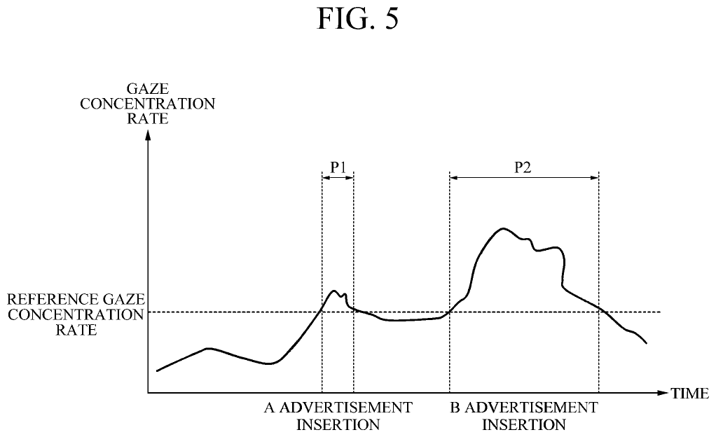

FIG. 5 is a graph illustrating a state of determining a section in which an advertisement will be inserted into content and a type of the advertisement in an embodiment of the present invention. Here, for convenience of description, it will be described as an example that the content providing device 102 is broadcasting the content to various user terminals 104 in live broadcast or streaming broadcast. However, the present invention is not limited thereto, and such a method may also be applied to the recorded content or content linked and accessed through URL or the like.

to FIG. 5, when the content is provided to each user terminal 104, each user terminal 104 generates gaze tracking information of a user and transmits the gaze tracking information of the user to the gaze analysis server 106, and the gaze analysis server 106 generates gaze analysis information for the corresponding content in real time based on the gaze tracking information of each user and transmits the gaze analysis information to the content providing device 102.

Then, the content providing device 102 may check the gaze concentration rate for each unit section for the corresponding content while the content is being broadcast. Here, the advertisement management unit 115 may determine sections in which the gaze concentration rate for each unit section is equal to or higher than a preset reference gaze concentration rate as advertisement insertion sections P1 and P2.

In this case, the advertisement management unit 115 may match and insert an advertisement having a higher advertisement unit price as the gaze concentration rate for each unit section is higher in the advertisement insertion sections P1 and P2. That is, the advertisement management unit 115 may insert an advertisement having an advertisement unit price of A in the advertisement insertion section P1 and insert an advertisement having an advertisement unit price of B (higher than A) in the advertisement insertion section P2 which has a higher gaze concentration rate for each unit section than the advertisement insertion section P1. Here, the advertisement may be an image, a video, a star balloon, a message, a caption, an icon, a brand, etc. but the form of the advertisement is not limited thereto.

In addition, the advertisement management unit 115 may classify each advertisement into a rating according to an advertisement unit price in an advertisement database (not illustrated). That is, advertisements may be grouped in such a manner as to classify advertisements having the advertisement unit price equal to or higher than the preset first advertisement unit price into a first rating, and classify advertisements having the advertisement unit price less than the first unit price and higher than a second advertisement unit price into a second rating.

The advertisement management unit 115 may check the content rating of the content from the gaze analysis information of the content received from the gaze analysis server 106, and extract an advertisement to be inserted into the corresponding content from among advertisement groups corresponding to the corresponding content rating. That is, the advertisement management unit 115 may extract an advertisement from among advertisement groups corresponding to the content rating of the corresponding content and insert the advertisement in a section (advertisement insertion section) in which the gaze concentration rate for each unit section of the corresponding content is equal to or higher than the preset reference gaze concentration rate. In this case, the advertisement management unit 115 may match and insert an advertisement having a high advertisement unit price among corresponding advertisement groups as the gaze concentration rate for each unit section is higher.

Here, it has been described that the advertising unit price of each advertisement is determined, but is not limited thereto, and after the advertisement is inserted in the advertisement insertion section of the content, the advertisement unit price may be calculated later. In this case, the advertising unit price may be determined according to the gaze concentration rate for each unit section.

Meanwhile, the advertisement management unit 115 may insert the advertisement in the section (that is, the advertisement insertion section) in which the gaze concentration rate for each unit section of the content is equal to or higher than the preset reference gaze concentration rate, but may insert the advertisement in a region in the content where the fixation density of users is highest or in the vicinity of the region.

Here, it is illustrated that the gaze analysis information for the content is generated by the gaze analysis server 106 based on the gaze tracking information and sent to the content providing device 102, but is not limited thereto, and the content providing device 102 may receive the gaze tracking information from the user terminal 104 to generate gaze analysis information for the content.

According to the disclosed embodiment, it is possible to check the degree of gaze concentration for each section of each piece of content by generating the gaze analysis information based on the gaze tracking information of the user of each piece of content. Through this, it is possible to check the section with good advertisement effect in the content and insert the advertisement thereto, and calculate the advertisement unit price differently according to the degree of gaze concentration for each unit section.

Meanwhile, the content providing device 102 may be a computing device for personal broadcasting (e.g., African TV or YouTube). The content providing device 102 may include a gaze tracking unit for generating gaze tracking information by tracking a gaze of a personal broadcasting operator. In this case, an advertisement may be inserted into personal broadcasting content by comparing a gaze position of the personal broadcasting operator with a gaze position of the user who is watching the personal broadcasting. For example, when the gaze position of the personal broadcasting operator is coincident with the gaze position of the user who is watching the personal broadcasting, an advertisement may be inserted at a corresponding position of the personal broadcasting content.

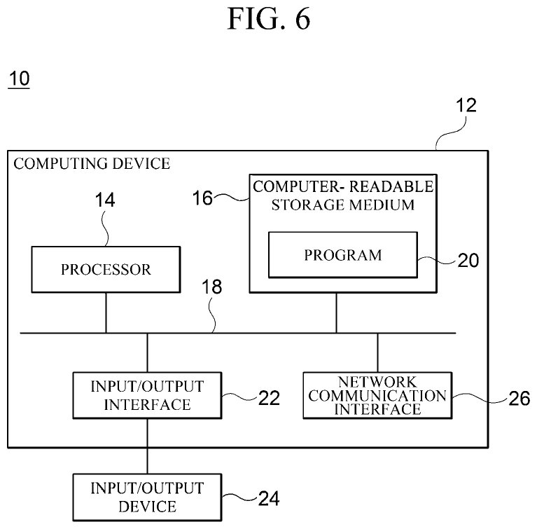

FIG. 6 is a block diagram illustrating and exemplifying a computing environment 10 that includes a computing device suitable for use in the exemplary embodiment. In the illustrated embodiment, each component may have different functions and capabilities in addition to those described below, and additional components may be included in addition to those described below.

The illustrated computing environment 10 includes a computing device 12. In one embodiment, the computing device 12 may be the content providing device 102. Further, the computing device 12 may be the user terminal 104. Further, the computing device 12 may be the gaze analysis server 106.

The computing device 12 includes at least one processor 14, a computer-readable storage medium 16, and a communication bus 18. The processor 14 may cause the computing device 12 to be operated according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and can store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Although the representative embodiments of the present invention have been described in detail as above, those skilled in the art to which the present invention pertains will understand that various modifications may be made thereto within the limit that do not depart from the scope of the present invention. Therefore, the scope of rights of the present invention should not be limited to the described embodiments, but should be defined not only by claims set forth below but also by equivalents of the claims.

1. A method for gaze analysis performed in a computing device comprising one or more processors and a memory storing one or more programs executed by the one or more processors, the method for gaze analysis comprising:
acquiring gaze tracking information of each user for video content;
calculating a degree of gaze concentration for each unit section of the video content based on the gaze tracking information; and
calculating gaze concentration rate related information for the video content based on the degree of gaze concentration for each unit section.

2. The method of claim 1, wherein the gaze tracking information is generated in conjunction with a playback time of the video content while the video content is being played on a user terminal of the corresponding user, and is generated based on a detected Fixation, the Fixation being detected excluding Saccade from a gaze of the user.

3. The method of claim 2, wherein the calculating the degree of gaze concentration for each unit section comprises:
calculating a fixation density for each unit section for the video content of the corresponding user based on the gaze tracking information of each user; and
calculating a degree of gaze concentration for each unit section of users who have viewed the video content based on the fixation density for each unit section for the video content of each user.

4. The method of claim 3, wherein the calculating the gaze concentration rate related information comprises:
calculating a gaze concentration rate for each unit section of the video content based on the gaze concentration rate for each unit section of the users who have viewed the video content;
summing the gaze concentration rate for each unit section of the video content and dividing the summed gaze concentration rate by the total number of unit sections of the video content to calculate a total gaze concentration rate of the video content;
indexing a degree of user interest for video content according to one or more of an age, a gender, and a district of the users who have watched the video content based on the gaze concentration rate for each unit section and the total gaze concentration rate of the video content; and
recommending the video content to a predetermined user according to the degree of user interest indexed according to one or more of the age, the gender, and the district of the users.

5. The method of claim 3, wherein the calculating the gaze concentration rate related information comprises calculating a gaze concentration rate for each unit section of the video content based on the degree of gaze concentration for each unit section of the users who have viewed the video content.

6. The method of claim 5, wherein the calculating the gaze concentration rate related information further comprises:
summing the gaze concentration rate for each unit section of the video content and dividing the summed gaze concentration rate by the total number of unit sections of the video content to calculate a total gaze concentration rate of the video content; and
assigning a content rating to the video content based on one or more of the gaze concentration rate for each unit section and the total gaze concentration rate of the video content.

7. The method of claim 6, further comprising:
calculating an advertisement unit price of each piece of content according to the content rating after the assigning the content rating.

8. The method of claim 5, wherein the calculating the gaze concentration rate for each unit section of the video content comprises:
calculating a gaze concentration rate for each unit section of the video content for each day of the week for users who have viewed the video content by day of the week; and
calculating a gaze concentration rate for each unit section of the video content for each season for users who have viewed the video content by season.

9. The method of claim 5, further comprising:
determining one or more of a type of advertisement to be included in the video content and an insertion section of the advertisement based on the gaze concentration rate related information for the video content.

10. The method of claim 9, wherein the determining comprises determining a section in which the gaze concentration rate for each unit section of the video content is equal to or higher than a preset reference gaze concentration rate as an advertisement insertion section.

11. The method of claim 10, further comprising:
inserting an advertisement into the advertisement insertion section after the determining as the advertisement insertion section,
wherein in the inserting the advertisement into the advertisement insertion section, the advertisement may be inserted in a region of the video content with the highest fixation density or in the vicinity of the region with the highest fixation density.

12. The method of claim 9, wherein the determining comprises:
summing the gaze concentration rate for each unit section of the video content and dividing the summed gaze concentration rate by the total number of unit sections of the video content to calculate a total gaze concentration rate of the video content;
assigning a content rating to the video content based on one or more of the gaze concentration rate for each unit section and the total gaze concentration rate of the video content;
extracting an advertisement group corresponding to the content rating of the video content from among preset advertisement groups;
determining a section in which the gaze concentration rate for each unit section of the video content is equal to or higher than a preset reference gaze concentration rate as an advertisement insertion section; and
extracting an advertisement from the extracted advertisement group according to the gaze concentration rate for each unit section of the video content to insert the advertisement into the advertisement insertion section.

13. A computing device comprising:
one or more processors;
a memory; and
one or more programs, wherein
the one or more programs are stored in the memory and configured to be executed by the one or more processors, and
the one or more programs comprise:
an instruction for acquiring gaze tracking information of each user for video content;
an instruction for calculating a degree of gaze concentration for each unit section of the video content based on the gaze tracking information; and
an instruction for calculating gaze concentration related information for the video content based on the degree of gaze concentration for each unit section.

14. A computing device comprising:
one or more processors;
a memory; and
one or more programs,
wherein the one or more programs are stored in the memory and configured to be executed by the one or more processors; and
the one or more programs comprise:
an instruction for acquiring video content;
an instruction for acquiring gaze tracking information of each user for video content; and
an instruction for calculating a degree of gaze concentration of the user for each unit section of the video content based on the gaze tracking information; and
the gaze tracking information is generated in conjunction with the playback time of the video content while the video content is being played on the computing device, and is generated based on a detected Fixation, the Fixation being detected excluding Saccade from a gaze of the user.
